(19) United States
(12) Patent Application Publication
(10) Pub. No.: US 2007/0169646 A1
(43) Pub. Date: Jul. 26, 2007

(54) Printing spacers on LCD substrates

(75) Inventors: Bong-Sung Seo, Gyeonggi-do (KR); So-Youn Park, Gyeonggi-do (KR); Jeong-Uk Heo, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/606,648

(22) Filed: Nov. 29, 2006

(30) Foreign Application Priority Data
Jan. 23, 2006 (KR) 2006-6897

(51) Int. Cl. B41M 1/14

(52) U.S. Cl. 101/211

(57) ABSTRACT

Apparatus and methods for printing spacers on LCD substrates include a printing roller and a planarizing unit. The printing roller picks up a plurality of spacer ink dots, each containing a plurality of minute, rigid, spherical spacers, onto an outer surface thereof and prints them on an LCD substrate at selected locations thereon. The planarizing unit is spaced apart from the outer surface of the printing roller and operates to planarize the spacers such that the spacers are arranged in a single layer having a uniform height substantially equal to the diameter of the spacers. The planarizing unit thereby prevents the spacers from being printed on the substrate in multiple layers such that the cell gap between the substrates of the LCD does not vary, but is uniform in height, thereby improving the quality of the image produced by the display.

### RELATED APPLICATIONS

This application claims priority of Korean Patent Application No. 2006-6897, filed Jan. 23, 2006, the entire contents of which are incorporated herein by reference.

### BACKGROUND

The present invention relates to apparatus and methods for printing spacers on liquid crystal display (LCD) substrates such that the image quality of the displays is improved.

Typically, an LCD displays an image using the optical and electrical properties of a liquid crystal material. LCDs have several desirable performance characteristics when compared to other display types, such as cathode ray tubes, plasma display panels and the like, including a lighter weight, lower power consumption, lower driving voltages, and others.

An LCD typically includes a panel that displays an image using the light transmittance of a layer of the liquid crystal material contained therein and a backlight assembly disposed below the panel that providing it with light. The display panel includes an array substrate having a plurality of switching elements, such as thin-film transistors (TFTs), a color filter substrate that faces the array substrate and has a plurality of color filters disposed thereon, a layer of a liquid crystal material interposed between the two substrates, a seal line disposed between and extending around the peripheries of the two substrates that seals the liquid crystal layer between the two substrates, and a plurality of spacers disposed between the two substrates that hold them spaced apart from each other at a selected distance, or “cell gap.”

Various methods have been used to form the layer of liquid crystal material between the substrates, include a method in which the liquid crystal material is injected between the two panels, and more recently, a method in which droplets of the liquid crystal material are dropped onto a surface of one of the two substrates before they are assembled together. The latter, “dropping” method includes the following steps: A seal line and a plurality of spacers are formed on the color filter substrate. A plurality of droplets of the liquid crystal material is dropped on the array substrate. The color filter substrate is then combined with the array substrate in a vacuum condition to form the display panel.

The spacers are typically printed on the color filter substrate through a printing process using a printing roller. In particular, the printing roller is rotated over a printing plate to transfer a plurality of small volumes, or “dots,” of a “spacer ink,” i.e., a liquid carrier in which a plurality of minute, rigid spherical spacers are dispersed, that were previously distributed on the printing plate, onto an outer surface of the printing roller. The printing roller is then rotated over the color filter substrate to print the spacer ink dots onto the color filter substrate at positions corresponding to the positions at which the dots of spacer ink were distributed on the printing plate.

When the spacer dots are transferred onto the surface of the printing roller, it is possible for the spacers in each ink dot to be arranged in multiple layers, i.e., stacked on top of each other.

When the dots are then transferred to the surface of the color filter substrate by the printing roller, the spacers can be transferred to the substrate in this stacked arrangement. However, when the spacers are printed on the color filter substrate in such a stacked arrangement, the cell gap formed between the array substrate and the color filter substrate can vary irregularly. When this occurs, the quality of the image displayed by the display panel is substantially deteriorated.

### BRIEF SUMMARY

In accordance with the exemplary embodiments thereof described herein, the present invention provides methods and apparatus for printing spacers on a substrate of an LCD panel that overcome the above and other problems of the prior art.

In one exemplary embodiment thereof, a spacer printing apparatus includes a printing roller and a planarizing unit. The printing roller picks up, or adheres, a plurality of spacer ink dots onto an outer surface thereof and then prints the spacer ink dots at selected locations on an LCD substrate. The planarizing unit is spaced apart from the outer surface of the printing roller and functions to planarize the dots of spacer ink so that the spacers contained in each of the dots are arranged in a single plane, or layer, having a substantially uniform height that is equal to the diameter of the spacers.

The planarizing unit may comprise a pressing roller that rotates against the printing roller so as to press the spacers adhering to the outer surface thereof into a single layer. Alternatively, the planarizing unit can comprise a planarizing blade having an end portion with a rounded shape that presses the spacers adhering to the outer surface of the printing roller to planarize them. The curvature of the end portion of the planarizing blade can be configured such that the profile of a gap between the end portion of the planarizing unit and the outer surface of the printing roller curves only slightly in the direction of rotation of the printing roller so as to prevent the spacers from clumping at the end portion of the planarizing unit.

An exemplary embodiment of a method for manufacturing a display panel in accordance with the present invention comprises planarizing the spacers contained in a plurality of spacer ink dots adhered to an outer surface of a printing roller such that the spacers dispersed in the ink dots are arranged in a single layer. The printing roller is then rotated over and in rolling engagement with a first LCD substrate to print the spacers on the first substrate. A seal line is formed on the first substrate. A plurality of droplets of a liquid crystal material is dropped onto a second substrate. The first substrate is then combined with the second substrate such that the liquid crystal material forms a layer that is sealed between the two substrates.

In one exemplary embodiment, the spacer ink dots may be disposed in respective ones of a plurality of receiving recesses in a printing plate. The printing roller is rotated over the printing plate to adhere the ink dots to the outer surface of the printing roller at respective longitudinal and lateral positions corresponding to those of the recesses of the printing plate. The ink dots are then pressed by a planarizing unit disposed adjacent to the outer surface of the printing roller so as to planarize the spacers in each of the dots so that the spacers are arranged in a single layer on the outer surface of the printing roller. The printing roller is then rolled over a surface of an LCD to transfer the planarized spacers in the dots of spacer ink from the roller onto the substrate at respective lateral and longitudinal positions corresponding to those of the ink dots on the printing roller.

In accordance with the above exemplary embodiments of the invention, a planarizing unit prevents the spacers dispersed in a plurality of spacer ink dots that are adhered to an outer surface of a printing roller from being arranged in a stacked fashion, so that when the spacers are printed on a surface of an LCD substrate by the printing roller, the spacers are arranged in a single layer. Thus, the cell gap between the substrates of the LCD is substantially uniform in height or thickness so that the quality of the image produced by the display is thereby improved.

A better understanding of the above and many other features and advantages of the LCD substrate spacer printing methods and apparatus of the present invention may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is a schematic side elevation view in partial cross section of an exemplary embodiment of a spacer printing apparatus in accordance with the present invention;

FIG. 2 is an enlarged cross-sectional detail view of a region of the exemplary apparatus of FIG. 1 encircled by the line ‘A’, showing a dot of spacer ink adhering to an outer surface of a printing roller of the apparatus;

FIG. 3 is an enlarged cross-sectional detail view of a region of the exemplary apparatus of FIG. 1 encircled by the line ‘B’, showing a dot of spacer ink adhering to the outer surface of the printing roller after being planarized by a planarizing roller of the apparatus;

FIG. 4 is a schematic side elevation view in partial cross section of another exemplary embodiment of a spacer printing apparatus in accordance with the present invention;

FIG. 5 is a schematic side elevation view in partial cross section of yet another exemplary embodiment of a spacer printing apparatus in accordance with the present invention; and,

FIGS. 6 to 11 are schematic side elevation views in partial cross section illustrating sequential steps of an exemplary embodiment of a method for manufacturing an LCD display panel in accordance with the present invention.

### DETAILED DESCRIPTION

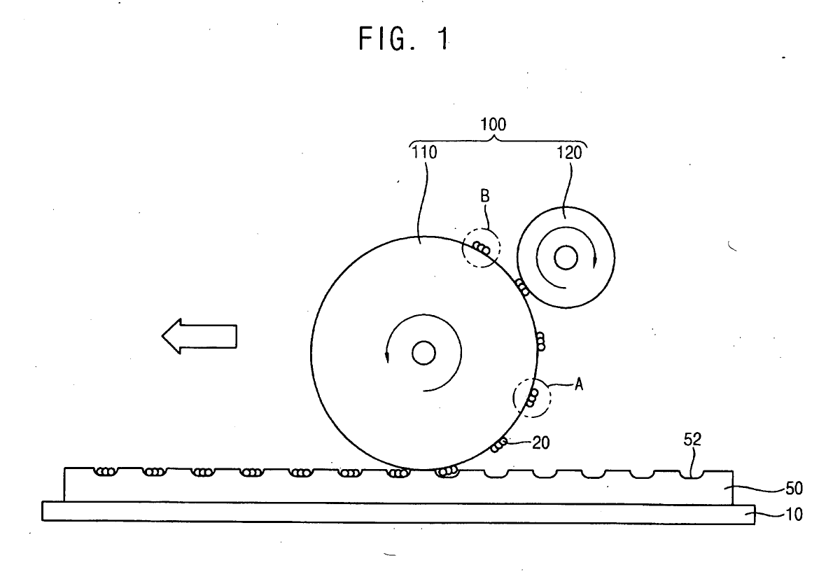

FIG. 1 is a schematic side elevation view in partial cross section of an exemplary embodiment of a spacer printing apparatus 100 in accordance with the present invention. As illustrated in FIG. 1, the apparatus 100 includes a printing roller 110 and a planarizing unit 120. The printing roller 110 has a plurality of spacer ink dots, each having a plurality of minute, rigid, spherical spacers 20 dispersed therein, adhering to an outer surface of the roller 110, and functions to print the spacer 20 ink dots onto an LCD substrate (not illustrated in FIG. 1) in the following manner.

As illustrated in FIG. 1, the printing roller 110 is translated over a printing plate 50 in the direction indicated by the large arrow while the roller simultaneously rotates in rolling engagement with an upper surface of the printing plate in the direction indicated by the small arrow, such that a plurality of spacer 20 ink dots respectively contained in a plurality of ink dot receiving recesses 52 contained in the upper surface of the printing plate are picked up by, or adhered to, an outer surface of the printing roller 110. The receiving recesses 52 are disposed at respective selected lateral and longitudinal pitches in the upper surface of the printing plate 50, i.e., are spaced apart from each other by respective selected lateral and longitudinal distances, such that the ink dots are transferred from the recesses to the printing roller 220 at the same lateral and longitudinal pitches at which they were disposed on the printing plate.

The ink-dot receiving recesses 52 are sized such that the ink dots respectively received therein each include a plurality of the spacers 20. For example, seven or eight of the spacers 20 may be contained in the ink dot received in each recess 52. The printing roller 110 is moved over the printing plate 50 while the latter is disposed on a stage 10 so that the spacer ink dots received in the receiving recesses 52 all selectively adhere to the outer surface of the printing roller 110. For this purpose, the outer surface of the printing roller 110 may be coated with an elastic synthetic resin that enables the spacer 20 ink dots to adhere more readily to the outer surface of the printing roller 110 than to the surface of the printing plate 50.

The printing roller 110 then prints the spacers 20 adhering to its outer surface on the LCD substrate. In particular, the printing roller 110 is translated over the LCD substrate while the roller is in simultaneous rolling engagement with an upper surface of the substrate, such that the plurality of spacer 20 ink dots adhering to the outer surface of the printing roller 110 are printed on the substrate at the selected longitudinal and lateral pitches or spacings described above.

In the particular exemplary embodiments described herein, each of the spacers 20 has a spherical shape, with a diameter of from about 3 μm to about 5 μm, and preferably, about 4 μm (1 μm=1×10⁻⁶ meter). The spacers 20 may comprise, for example, an elastic polymer, such as di-vinyl benzene. The spacers 20 are preferably randomly dispersed in a liquid thermosetting ink carrier 30 having a selected, controlled viscosity.

The planarizing unit 120 of the apparatus 100 functions to planarize the spacers 20 contained in the spacer ink dots on the outer surface of the printing roller 110 in the following manner. The planarizing unit 120 is spaced apart from the outer surface of the printing roller 110 by a selected distance. The distance is preferably substantially the same as the average diameter of the spacers 20, i.e., in the exemplary embodiment described above, from about 3 μm to about 5 μm.

In the exemplary embodiment of FIG. 1, the planarizing unit 120 comprises a pressing roller that rotates against the printing roller so as to press the spacers 20 adhering to the outer surface of the printing roller 110 against the outer surface thereof, and thereby arrange them into a single layer of spacers having a height above the outer surface of the printing roller that is substantially equal to the average diameter of the spacers. In this embodiment, the pressing roller rotates in a direction opposite to the direction of rotation of the printing roller 110 and has a diameter that is smaller than the diameter of the printing roller 110.

The planarizing unit 120 may include a buffering member (not illustrated) that prevents the spacers 20 from being damaged or deformed by the impacts and pressures exerted on them by the two rollers. Examples of buffering members that can be used include an elastic synthetic resin formed on the outer surface of the pressing roller 110, or a spring on the axle of the pressing roller, and the like.

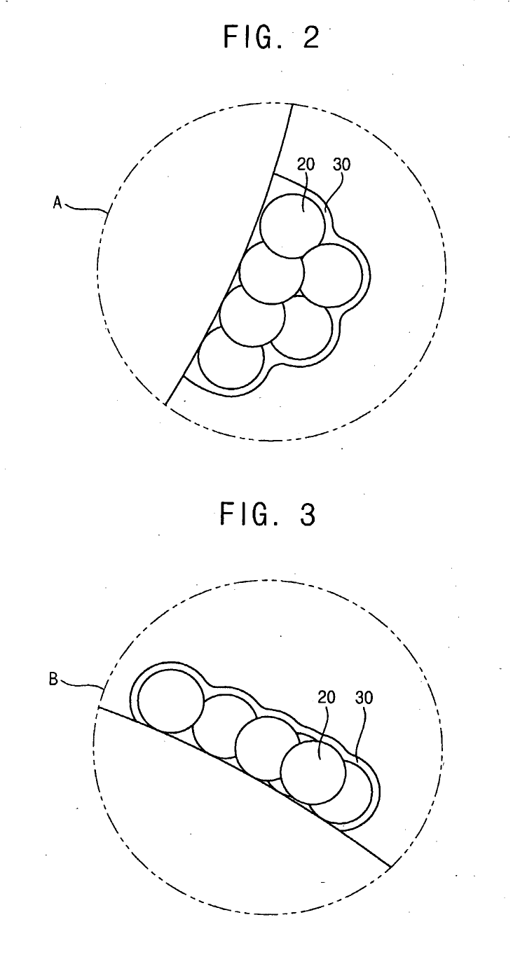

FIG. 2 is an enlarged cross-sectional detail view of a region of the exemplary printing apparatus of FIG. 1 encircled by the line ‘A’, showing a dot of spacer 20 ink adhering to an outer Surface of a printing roller of the apparatus, and FIG. 3 is an enlarged cross-sectional detail view of a region of the exemplary apparatus of FIG. 1 encircled by the line ‘B’, showing a dot of spacer ink adhering to the outer surface of the printing roller after being planarized by a planarizing roller of the apparatus.

Referring to FIG. 2, the spacers 20 in the spacer ink dots picked up from the printing plate 52 by the printing roller 110 and adhering to its outer surface are arranged a double-thickness layer. However, it should be understood that it is possible for the spacers 20 in the ink dots to be arranged in multiple layers thereof having an even greater thickness, such as in double or triple layers.

FIG. 3 illustrates the spacers 20 in an ink dot adhering to the outer surface of the printing roller 110 after being planarized by the planarizing unit 120 into a single layer of the spacers. As described above, in the embodiment of FIG. 1, the spacers 20 are pressed between the printing roller 110 and the planarizing unit 120 rotating in opposite directions such that the spacers 20 are arranged in a single layer on the outer surface of the printing roller 110. That is, after being planarized, the spacers 20 in each ink dot are arranged in a single layer having a height above the outer surface of the printing roller that is substantially equal to the average diameter of the spacers.

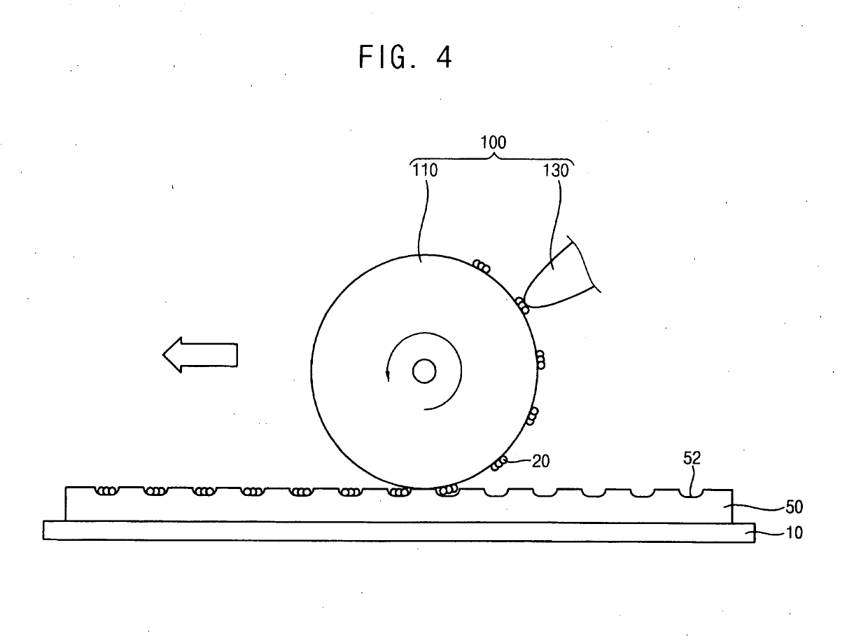

FIG. 4 is a schematic side elevation view partially in cross section of another exemplary embodiment of a spacer printing apparatus in accordance with the present invention. The spacer printing apparatus of FIG. 4 is substantially similar to the spacer printing apparatus of FIG. 1 except for the planarizing unit 130 thereof. Therefore, further description of the similar elements is omitted for brevity.

As illustrated in FIG. 4, the planarizing unit 130 can comprise a planarizing blade that is spaced apart from the outer surface of the printing roller 110 by a selected distance. The selected distance is preferably substantially the same as the diameter of the spacers 20, for example, from about 3 μm to about 5 μm.

An end portion of the planarizing unit 130 that faces toward the printing roller 110 is preferably provided with a rounded shape. The rounded end portion of the planarizing unit 130 presses the spacers 20 of the ink dots against the moving outer surface of the printing roller so that the spacers 20 in each ink dot are rearranged into a single layer of the spacers having a height above the outer surface of the printing roller that is substantially equal to the average diameter of the spacers.

As in the embodiment of FIG. 1 above, the planarizing unit 130 may further include a buffering member (not illustrated) that prevents the spacers 20 from being damaged by the impacts and pressures applied to the spacers 20 when they pass between the rotating printing roller and the stationary planarizing unit.

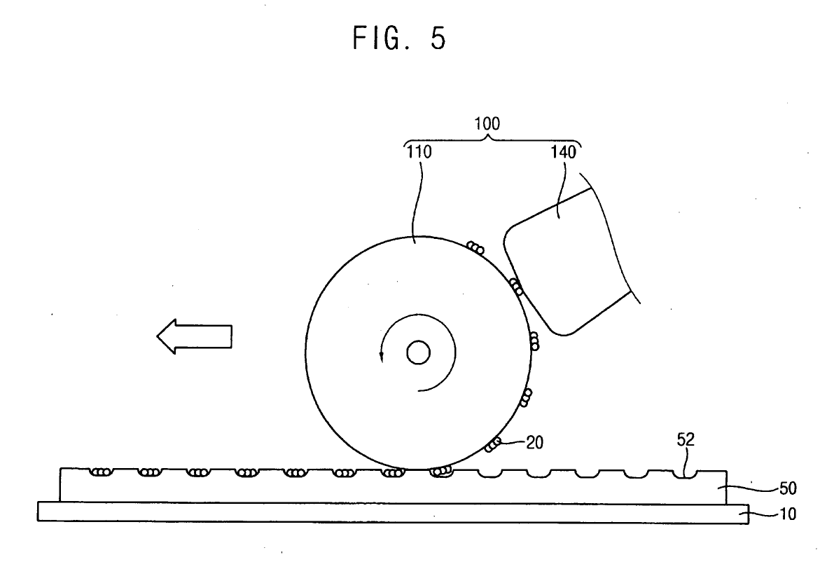

FIG. 5 is a schematic side elevation view in partial cross section of yet another exemplary embodiment of a spacer printing apparatus 100 in accordance with the present invention. The apparatus of FIG. 5 is substantially similar to the apparatus of FIGS. 1 and 4, except for the configuration of the planarizing unit 140 thereof. In the exemplary apparatus of FIG. 5, the planarizing unit 140 comprises a planarizing blade that is spaced apart from an outer surface of the printing roller 110 by a selected distance, preferably, by about the average diameter of the spacers 20, i.e., from about 3 μm to about 5 μm.

As illustrated in FIG. 5, the end portion of the planarizing unit 140 that faces the printing roller 110 has a rounded shape with a curvature that is substantially less than the curvature of the end portion of the planarizing unit 130 illustrated in FIG. 4. That is, the profile of the gap between the end portion of the planarizing unit 140 and the outer surface of the printing roller 110 of FIG. 5 varies much more gradually in the direction of rotation of the printing roller 110 than does the gap between the end portion of the planarizing unit 130 and the outer surface of the printing roller 110 of the embodiment of FIG. 4.

As in the embodiments of FIGS. 1 and 4, the end portion of the planarizing unit 140 of FIG. 5 functions to press the spacers 20 of the ink dots against the rotating outer surface of the printing roller so that the spacers 20 in each ink dot are arranged in a single layer having a height above the outer surface of the printing roller that is substantially uniform and equal to about the average diameter of the spacers. However, since the profile of the gap between the end portion of the planarizing unit 140 and the outer surface of the printing roller 110 varies more gradually in the direction of rotation of the printing roller 110, the spacers 20 are prevented from clumping at the end portion of the planarizing unit 140.

As in the above embodiments, the planarizing unit 140 may include a buffering member (not illustrated) that prevents the spacers 20 from being damaged by the impacts and pressures applied to the spacers 20 when they pass between the printing roller and the planarizing unit.

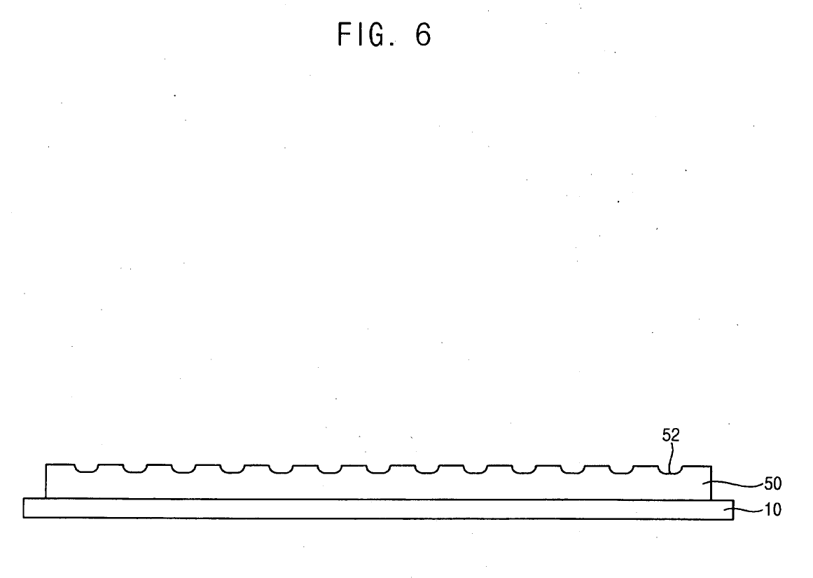

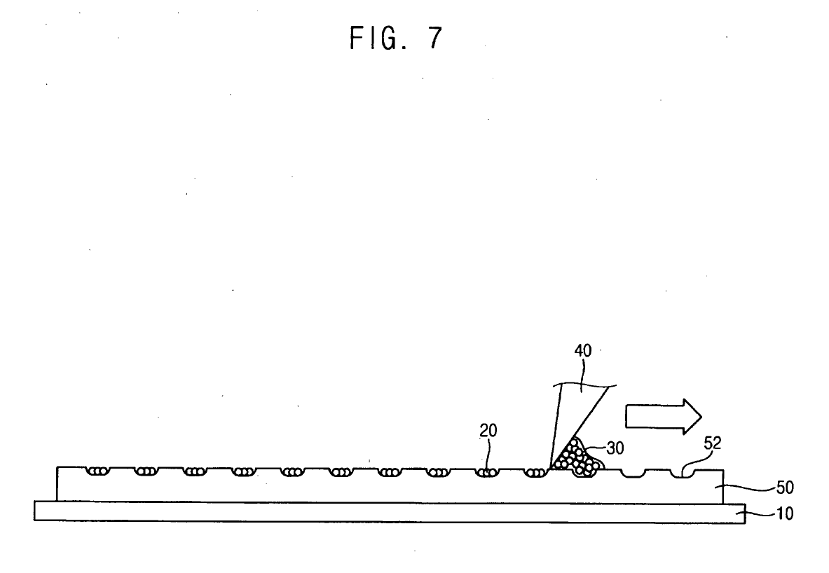

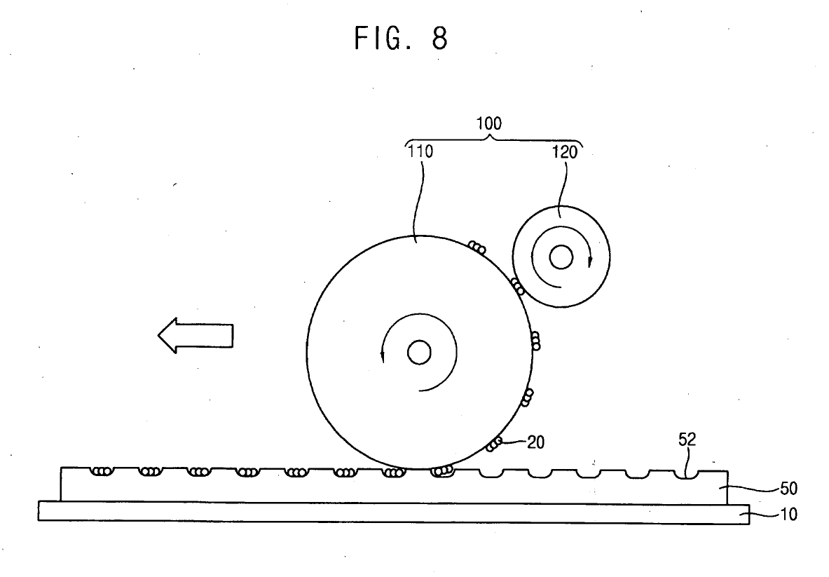

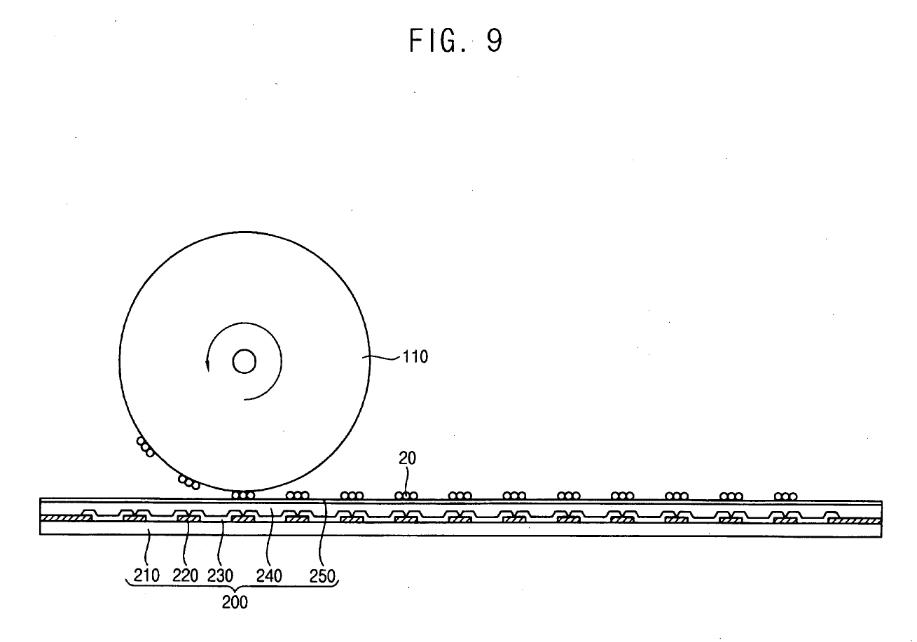

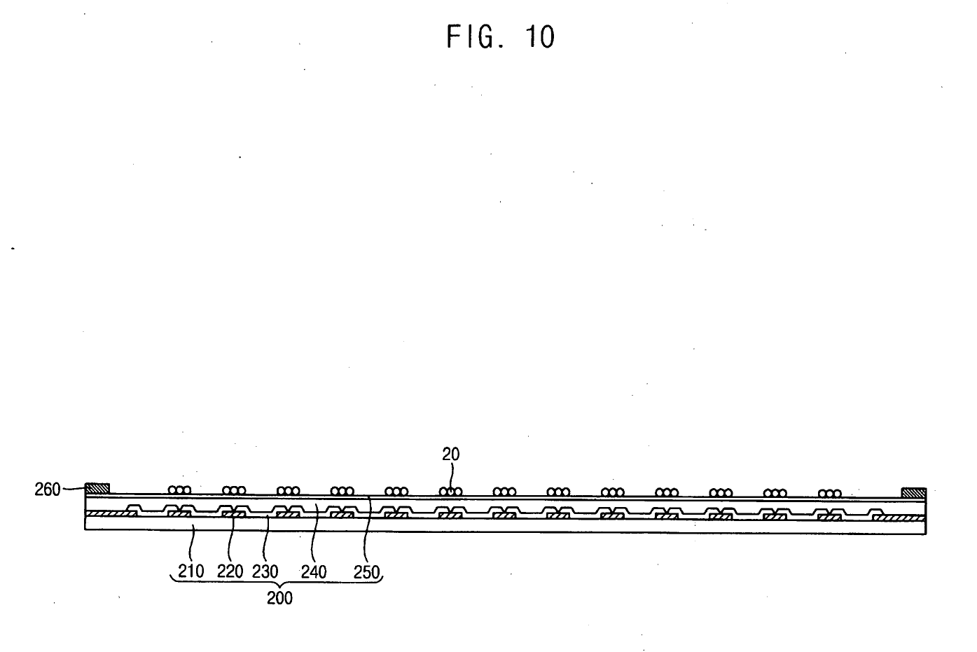

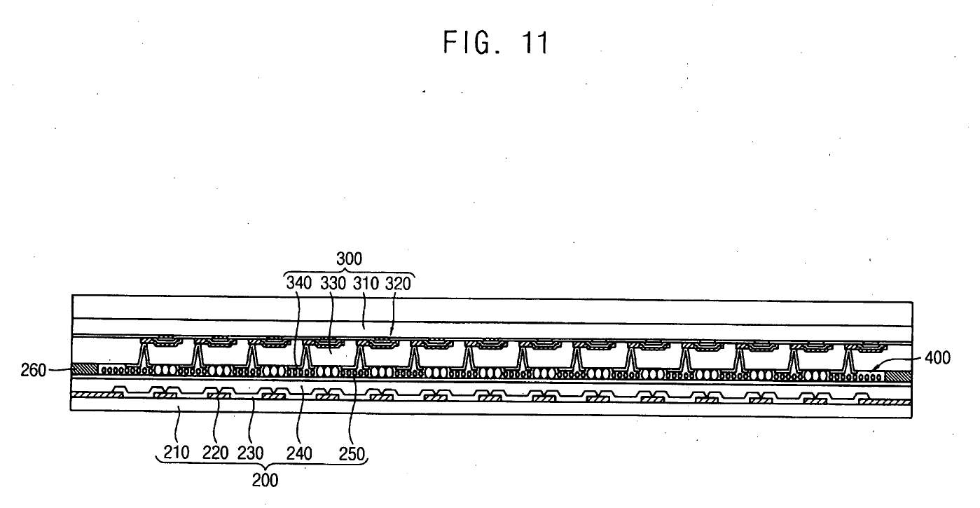

FIGS. 6 to 11 are schematic side elevation views in partial cross section illustrating sequential steps involved in an exemplary embodiment of a method for manufacturing an LCD display panel in accordance with the present invention. FIG. 7 illustrates disposing a plurality of spacer ink dots, each containing a plurality of spacers 20 dispersed therein, into a plurality of receiving recesses 52 of a printing plate 50. FIG. 8 illustrates the spacer 20 ink dots being transferred from the recesses 52 of the printing plate 50 onto an outer surface of a printing roller 110. FIG. 9 illustrates the printing roller printing the spacers 20 of the ink dots on a first LCD substrate 200. FIG. 10 illustrates forming a seal line on the first substrate 200. FIG. 11 illustrates the first substrate 200 being combined with a second substrate to form an LCD display panel.

Referring to FIG. 6, a printing plate 50 having a plurality of spacer-ink dot receiving recesses 52 in an upper surface thereof is disposed on a stage 10. The receiving recesses 52 are disposed at selected respective lateral and longitudinal pitches, i.e., spaced apart from each other by selected respective lateral and longitudinal distances. For example, the receiving recesses 52 may be arranged in a rectangular matrix configuration having lateral rows and longitudinal columns when viewed in a plan view.

Referring to FIG. 7, a plurality of spacer ink dots, each containing a plurality of spacers 20, are respectively loaded into the receiving recesses 52 of the printing plate 50. For example, the spacer ink can be sprayed onto the upper surface of the printing plate 50 by a spacer ink sprayer (not illustrated). The spacers 20 may be randomly dispersed in a liquid ink carrier 30. The liquid ink carrier 30 preferably has a selected, controllable viscosity and thermosetting properties. Examples of the ink carrier 30 that may be used include white ink, melamine resin, polyester resin, and the like.

After the spacer 20 ink has been sprayed on the upper surface of the printing plate 50, a wiper blade 40 can be moved across the surface to force, or screed, the spacer 20 ink into the recesses 52. The wiping blade 40 may further function to remove any excess ink, i.e., any remaining ink that was not forced into the receiving recesses 52, from the surface of the printing plate 50 for disposal or reuse.

The depth of each of the receiving recesses 52 of the printing plate may be made substantially the same as the average diameter of the spacers 20, and their width may be from about 21 μm to about 25 μm so as to be capable of receiving from about seven to eight of the spacers 20.

Referring to FIG. 8, the printing roller 110 of the spacer printing apparatus 100 is simultaneously translated and rotated over and in rolling engagement with the upper surface of the printing plate 50 in the direction of the arrows shown so as to pick up, or adhere, the dots of spacer 20 ink respectively contained in the recesses 52 of the printing plate onto the outer surface of the printing roller 110. In particular, the printing roller 110 is rotated so as to make rolling contact with the upper surface of the printing plate 40 so that the dots of spacer 20 ink adhere to the outer surface of the printing roller 110. As described above, the viscosity of the ink carrier 30 and the respective outer and upper surfaces of the printing roller 110 and the printing plate 50 can be arranged such that the ink adheres more readily to the outer surface of the printing roller 110 than to the printing plate 50.

After the dots of spacer 20 ink are adhered to the outer surface of the printing roller 110, the spacers 20 are planarized by the planarizing unit 120 of the spacer printing apparatus 100, as described above, such that the spacers 20 in each ink dot are arranged in a single layer having a height above the outer surface of the printing roller 110 that is substantially equal to the average diameter of the spacers. Examples of suitable planarizing units that may be used include the pressing roller 120 described above with reference to FIGS. 1 to 3, and the planarizing blades 130 and 140 described above with reference to FIGS. 4 and 5, respectively. As those of skill in the art will appreciate, use of a pressing roller is preferable, since a planarizing blade may alter the circumferential position of the spacers 20 adhered to the outer surface of the printing roller 110 undesirably, i.e., smear, or spread them out too far circumferentially.

As illustrated in FIG. 9, after the spacers 20 of the spacer ink dots have been arranged into single layers by the planarizing unit, the printing roller 110 is simultaneously translated and rotated over a first LCD substrate 200 in rolling engagement therewith to print the dots of spacer 20 on the upper surface of the substrate. As above, the viscosity of the ink 30 and the respective surfaces of the roller 110 and the first substrate 200 may be arranged such that the spacer ink adheres more readily to the substrate than to the outer surface of the printing roller.

The first substrate 200 upon which the spacers 20 are printed may be a color filter substrate, including a first transparent substrate 210, a grid-shaped light-blocking layer 220, a plurality of color filters 230, a planarizing layer 240 and a common electrode 250. The grid of the light-blocking layer 220 is formed on a portion of the first transparent substrate 210. The color filters 230 cover the light-blocking layer 220. The planarizing layer 240 covers the color filters 230. The common electrode 250 is formed on the planarizing layer 240. The spacers 20 may be printed so as to overlie the grids of the light-blocking layer 220.

FIG. 10 illustrates the first substrate 200 after forming a seal line 260 thereon. The first substrate 200 may include an area that displays an image of the display and a peripheral area that surrounds the display area, and the seal line 260 may be formed in the peripheral area and be arranged in a closed-loop configuration. The seal line 260 may be formed of, for example, a sealant comprising a thermosetting material having a plurality of seal spacers (not shown) dispersed therein. The seal spacers are dispersed in the sealant to maintain the desired cell gap between the first substrate 200 and a second substrate 300, as described below.

In one exemplary embodiment of the method (not illustrated), a plurality of droplets of a liquid crystal material is dropped onto a second substrate 300. The second substrate 300 may comprise, for example, an array substrate that includes a second transparent substrate 310, a plurality of thin-film transistors (TFTs) 320, a protecting layer 330 and a plurality of pixel electrodes 340. The TFTs 320 are formed on the second transparent substrate 310. The protecting layer 330 covers the TFTs 320 to protect them. The pixel electrodes 340 are electrically connected to the TFTs 320 via contact holes formed in the protecting layer 330.

In the exemplary embodiment described and illustrated herein, the spacers 20 and the seal line 260 are formed on the first substrate 200 that has the color filters 230 thereon, and the liquid crystals are dropped onto the second substrate 300 that has the TFTs 320 thereon. However, it should be understood that, in an alternative embodiment (not illustrated), the spacers 20 and the seal line 260 may be formed on the second substrate 300, and the liquid crystals may be dropped onto the first substrate 200.

Referring to FIG. 11, the first substrate 200 is combined with the second substrate 300 to manufacture a display panel. The droplets of the liquid crystal material dropped onto the second substrate 300 spread out between the first substrate 200 and the second substrate 300 and coalesce to form a layer 400 of the liquid crystal material. The seal line 260 combines the first substrate 200 with the second substrate 300 and seals the gap between the two substrates so as to prevent the liquid crystal layer 400 from flowing out from between them.

After the two substrates 200 and 300 are combined, the seal line 260 is heated to a selected temperature for a selected period of time to cure the thermosetting seal line 260. While the seal line 260 is curing, the liquid carrier 30 of the spacer ink in which the spacers 20 are dispersed may also be cured simultaneously. When the ink is cured, each of the spacers 20 is thereby secured on the substrate at the respective lateral and longitudinal positions at which they were printed thereon by the printing apparatus 100.

In the exemplary embodiments described above, the planarizing unit 120 functions to arrange the spacers 20 adhered to the outer surface of a printing roller 110 into a single layer having a thickness substantially equal the average diameter of the spacers. As a result, the planarizing unit prevents the spacers from being printed on an LCD substrate in a stacked arrangement, i.e., in multiple layers, so that the spacers are all disposed at the same height on the substrate. Thus, the cell gap between the substrates of the LCD is maintained at a uniform spacing such that the quality of the image displayed by the LCD is improved.

By now, those of skill in this art will appreciate that many modifications, substitutions and variations can be made in and to the spacer printing methods and apparatus of the present invention and their advantageous application to the manufacture of LCD substrates without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A spacer printing apparatus, comprising:
a printing roller that adheres a plurality of dots of an ink containing spacers onto an outer surface thereof and prints the spacer ink dots on a substrate; and,
a planarizing unit that is spaced apart from the outer surface of the printing roller and is operable to planarize the spacers contained in each of the ink dots such that the spacers are arranged in a single layer having a substantially uniform height above the outer surface of the printing roller.

2. The spacer printing apparatus of claim 1, wherein the planarizing unit is spaced apart from the outer surface of the printing roller by a distance that is substantially equal to a diameter of the spacers.

3. The spacer printing apparatus of claim 1, wherein the planarizing unit comprises a pressing roller that rotates against the outer surface of the pressing roller so as to press the spacers adhered to the outer surface thereof.

4. The spacer printing apparatus of claim 3, wherein the pressing roller and the printing roller rotate in opposites directions.

5. The spacer printing apparatus of claim 1, wherein the planarizing unit comprises a planarizing blade having an end portion that presses the spacers adhered to the outer surface of the printing roller so as to planarize the spacers, and wherein the end portion of the planarizing blade has a rounded shape.

6. The spacer printing apparatus of claim 5, wherein the profile of a gap between the end portion of the planarizing unit and the outer surface of the printing roller varies gradually in a direction of rotation of the printing roller.

7. The spacer printing apparatus of claim 1, wherein the planarizing unit comprises a buffering member operable to absorb impacts and pressures applied to the spacers when they pass between the planarizing unit and the rotating printing roller.

8. The spacer printing apparatus of claim 1, wherein each of the spacers has a spherical shape.

9. The spacer printing apparatus of claim 8, wherein the spacers have a diameter of from about 3 μm to about 5 μm.

10. A method of manufacturing a display panel, the method comprising:
planarizing a plurality of spacers contained in each of a plurality of spacer ink dots adhered to an outer surface of a printing roller;
rotating the printing roller over and in rolling engagement with a first display panel substrate to print the spacer ink dots on the first substrate;
forming a seal line on the first substrate;
dropping a plurality of droplets of a liquid crystal material on a second display panel substrate; and,
combining the first substrate with the second substrate such that the liquid crystal material forms a layer that is sealed between the first and second substrates.

11. The method of claim 10, wherein planarizing the spacers comprises:
loading the spacer ink dots into respective ones of a plurality of receiving recesses in an upper surface of a printing plate;
rotating the printing roller over and in rolling engagement with the upper surface of the printing plate so as to adhere the spacer ink dots to the outer surface of the printing roller; and,
pressing the spacer ink dots between the outer surface of the printing roller and a planarizing unit spaced apart from the outer surface of the printing roller so as to arrange the spacers contained in each of the spacer ink dots in a single layer having a substantially uniform height above the outer surface of the printing roller.

12. The method of claim 11, wherein the height of the layer of the planarized spacers is substantially equal to a diameter of the spacers.

13. The method of claim 11, wherein loading the spacer ink dots into respective ones of the receiving recesses comprises:
spraying a liquid ink carrier containing the spacers on the upper surface of the printing plate; and,
moving a wiping blade across the upper surface of the printing plate so as to force the spacer containing ink into the receiving recesses.

14. The method of claim 13, wherein the liquid ink carrier is thermosetting.

15. The method of claim 11, wherein the planarizing unit comprises a pressing roller that rotates against the printing roller so as to press the spacers contained in each of the ink dots adhered to the outer surface thereof into a single layer.

16. The method of claim 15, wherein the pressing roller and the printing roller rotate in opposite directions.

17. The method of claim 11, wherein each of the spacer ink dots contains about seven or eight of the spacers.

18. The method of claim 17, wherein each of the receiving recesses has a width of from about 21 μm to about 25 μm.

19. The method of claim 10, wherein the first display panel substrate comprises a color filter substrate having a plurality of color filters, and the second substrate comprises an array substrate having a plurality of thin-film transistors (TFTs).

20. The method of claim 19, wherein the first display panel substrate further comprises a grid-shaped light-blocking layer for blocking light, and wherein the spacers overlie grid lines of the light-blocking layer.
